(19) United States
(12) Patent Application Publication
(10) Pub. No.: US 2017/0108154 A1
(43) Pub. Date: Apr. 20, 2017

(54) ELASTICALLY DEFORMABLE POLYMER ARTICLES AND METHODS OF USE FOR ABSORBING CYCLIC PRESSURE EXCURSIONS

(71) Applicant: SABIC Global Technologies B.V., Bergen op Zoom (NL)

(72) Inventors: Bret William Baumgarten, San Rafael, CA (US); Andrew W. May, East Greenbush, NY (US)

(21) Appl. No.: 15/127,957

(22) PCT Filed: Mar. 26, 2015
(86) PCT No.: PCT/US2015/022635

§ 371 Date: Sep. 21, 2016

Related U.S. Application Data
(60) Provisional application No. 61/970,747, filed on Mar. 26, 2014.

(51) Int. Cl. F16L 55/045; F16F 1/366; F16F 1/36

(52) U.S. Cl. CPC F16L 55/045; F16F 1/36; F16F 1/3605; F16F 1/366; F16F 2224/0241; E21B 21/00

(57) ABSTRACT

An elastically deformable article of manufacture can comprise a closed polymer shell having an outer surface, an inner surface, and an inner volume; a reinforcement in mechanical communication with an area of either the outer surface, the inner surface, or both the outer surface and the inner surface; wherein the closed polymer shell comprises a first polymer material having a thermal decomposition temperature of greater than or equal to 180° C.; wherein the article is configured such that the inner volume reduces from an initial inner volume as a pressure applied to the outer surface is increased to a threshold pressure and rebounds to greater than 75% of the initial inner volume as the pressure decreases from the threshold pressure over at least two pressure cycles.

### BACKGROUND

This invention relates to articles and methods for mitigating cyclic pressure changes in a system, in particular elastically deformable polymer particles that can mitigate cyclic pressure changes in piping systems.

A number of engineering systems that include piping to provide fluid communication between system elements are subject to pressure fluctuations in the piping during operation, for example manufacturing operations, recycling or purification operations such as wastewater operations, and drilling operations. Such pressure fluctuations can cause stress to the systems, eventually resulting in mechanical failure of the system. For example, in drilling operations, a piping system can be used to provide a fluid connection between a deposited resource and an above ground storage or distribution system. The internal pipe is generally isolated from the adjacent subterranean formations by a casing, providing an annulus. Fluid pressure within the annulus can fluctuate, resulting in cyclic pressure excursions. Left unmitigated, such pressure excursions can damage equipment or cause a rupture in the piping system. Any damage to the well can significantly affect drilling production, can add to production cost, or can lead to an environmental release of the fluid in the piping system.

Thus there is a need in the art for effectively mitigating annular pressure buildup within piping systems that is capable of reducing the magnitude of cyclic pressure excursions.

### BRIEF DESCRIPTION

An elastically deformable article of manufacture can comprise a closed polymer shell having an outer surface, an inner surface, and an inner volume; a reinforcement in mechanical communication with an area of either the outer surface, the inner surface, or both the outer surface and the inner surface; wherein the closed polymer shell comprises a first polymer material having a thermal decomposition temperature of greater than or equal to 180° C.; wherein the article is configured such that the inner volume reduces from an initial inner volume as a pressure applied to the outer surface is increased to a threshold pressure and rebounds to greater than 75% of the initial inner volume as the pressure decreases from the threshold pressure over at least two pressure cycles.

The above described and other features are exemplified by the following figures and detailed description.

### BRIEF DESCRIPTION OF THE DRAWINGS

The following figures are exemplary embodiments wherein the like elements are numbered alike.

FIG. 1 is an illustration of a cross-section of an article of manufacture including a reinforcement extending within the inner volume.

FIG. 2 is an illustration of a cross-section of an article of manufacture including protrusions and a gap therebetween.

FIG. 3 is an illustration of a cross-section of an article of manufacture including variable shell thickness.

FIG. 4 is an illustration of a cross-section of an article of manufacture including a second polymer within the inner volume.

FIG. 5 is an illustration of a cross-section of an article of manufacture formed from shell segments including flanges.

FIG. 6 is an illustration of a cross-section of an article of manufacture including a reinforcement in mechanical communication with the outer surface.

FIG. 7 is an illustration an article of manufacture having a reinforcement in mechanical communication with the inner surface.

### DETAILED DESCRIPTION

Disclosed herein is an article of manufacture that can be used to mitigate pressure excursions, such as annular pressure buildup, in a piping system. The article can include a closed shell of a polymeric material. The closed polymer shell (or shell) can have an inner surface and an outer surface. The inner surface of the shell can have any shape. The outer surface of the shell can have any shape. A cross section of the inner or outer surface of a shell can have a circular shape, elliptical shape, triangular shape, square shape, polygonal shape (e.g. any closed polygon), or a combination comprising at least one of the foregoing. The inner and outer surfaces of the shell can have the same shape. The shell thickness can be substantially uniform throughout the shell (e.g., allowing for slight variation during manufacturing due to tool imperfections, tool wear, local variation in polymer shrinkage or surface tension affects during shrinkage, and the like). The inner and outer surfaces of the shell can have different shapes. The shell thickness can vary throughout the shell. The shell thickness can have thicker and thinner areas as compared to the average thickness of the shell. The shell can have an irregular thickness, e.g., resulting from an extruded pellet including gas inclusions throughout where the shell can be a continuous portion of material that encloses an inner volume.

The inner or outer surfaces of the shell can have any surface texture. The inner or outer surfaces can be smooth. The inner or outer surfaces can be dimpled. The inner or outer surfaces can be rough.

A pressure gradient can form across the shell. Such a pressure gradient can form when a pressure along a surface of the shell changes more rapidly than the pressure on the opposing surface. The pressure gradient across the shell can act to deform the shape of the shell or change the inner volume of the shell. The outer surface of the shell can be subjected to a higher pressure than the inner surface of the shell. In this case, the shell can be compacted until the forces acting on the shell (or shell wall) equilibrate. The outer surface of the shell can be subjected to a lower pressure than the inner surface of the shell. In this case, the shell can expand until the forces acting on the shell equilibrate.

A pressure cycle as used herein can refer to a process where a first pressure differential exists across the shell corresponding to an initial inner volume of the shell, the pressure differential across the shell then increases to a second pressure differential, the pressure differential across the shell then decreases to a third pressure differential. The third pressure differential, or the pressure differential acting across the shell at the completion of one pressure cycle, can be different than the first pressure differential. The third pressure differential can be greater than the first pressure differential. The third pressure differential can be equal to the first pressure differential. The third pressure differential can be less than the first pressure differential. The first, second, and third pressure differentials can each be the result of a higher pressure acting on the outer surface of the shell and a lower pressure acting on the inner surface of the shell.

The article can include a reinforcement. The reinforcement can be employed to adjust the amount of compaction or expansion that an article undergoes during a pressure cycle. The reinforcement can counteract the pressure forces acting on the shell. The reinforcement can be used to tune the response of the article to a change in differential pressure across the shell, such as at what pressure differential an article begins to deform (onset of deformation), the extent of deformation, and the ability of the article to regain its original volume once the pressure differential is relaxed (rebound). The reinforcement can be in mechanical communication with a surface of the shell. The reinforcement can be in mechanical communication with the inner surface of the shell. The reinforcement can be in mechanical communication with the outer surface of the shell. The reinforcement can be in mechanical communication with both the inner and outer surfaces of the shell. The reinforcement can provide structural integrity to the shell such that the shell can elastically deform over a selected range of differential pressures acting across the shell. The reinforcement can prevent deformation along an area of the shell. The reinforcement can help prevent the shell from plastically deforming when subjected to a pressure differential across the shell such that it is able to regain its original shape or volume once the pressure differential is relaxed, e.g., at the completion of one or more pressure cycles.

The reinforcement can act as a spring which can store energy as it is compressed and use the stored energy to rebound once the compressive force is removed. The reinforcement can act as a spring which can store energy as it is expanded and use the stored energy to rebound once the expansion force is removed. The reinforcement can enhance the elastic characteristic of the article, such that the elastic deformation region of the article's stress-strain curve is altered. The structure of the shell can include a compaction initiator which is designed such that the shell can consistently begin compacting at a desired pressure differential or in a desired manner. Once the pressure differential starts to decrease the article can begin to rebound to its original shape or original inner volume. Following one or more pressure cycles the inner volume of the article can return to greater than or equal to 50% of its initial volume, for example, 50% to 95%, or, 70% to 90%.

The reinforcement can act to reduce the amount of deformation that an article will undergo until a predetermined pressure differential exists across the shell. At a predetermined pressure differential, or threshold pressure differential, the reinforcement can act to influence the deformation of the article as the pressure differential continues to increase. The threshold pressure differential can be selected for a specific application and articles of manufacture can be adjusted by various factors to meet the selected threshold pressure differential. Some factors that can influence the threshold pressure differential for an article include shell thickness, pressure of the inner volume, the material of the article, the strength of the article, and the shape of the article. These factors can influence the shape of the stress-strain curve of the article. The threshold pressure differential for an article can be selected from 345 kilopascals (kPa) to 105 megapascal (MPa), for example, 345 kPa to 75 MPa, or, 345 kPa to 50 MPa, or, 10 MPa to 25 MPa, and all pressure differentials between the ends of these ranges.

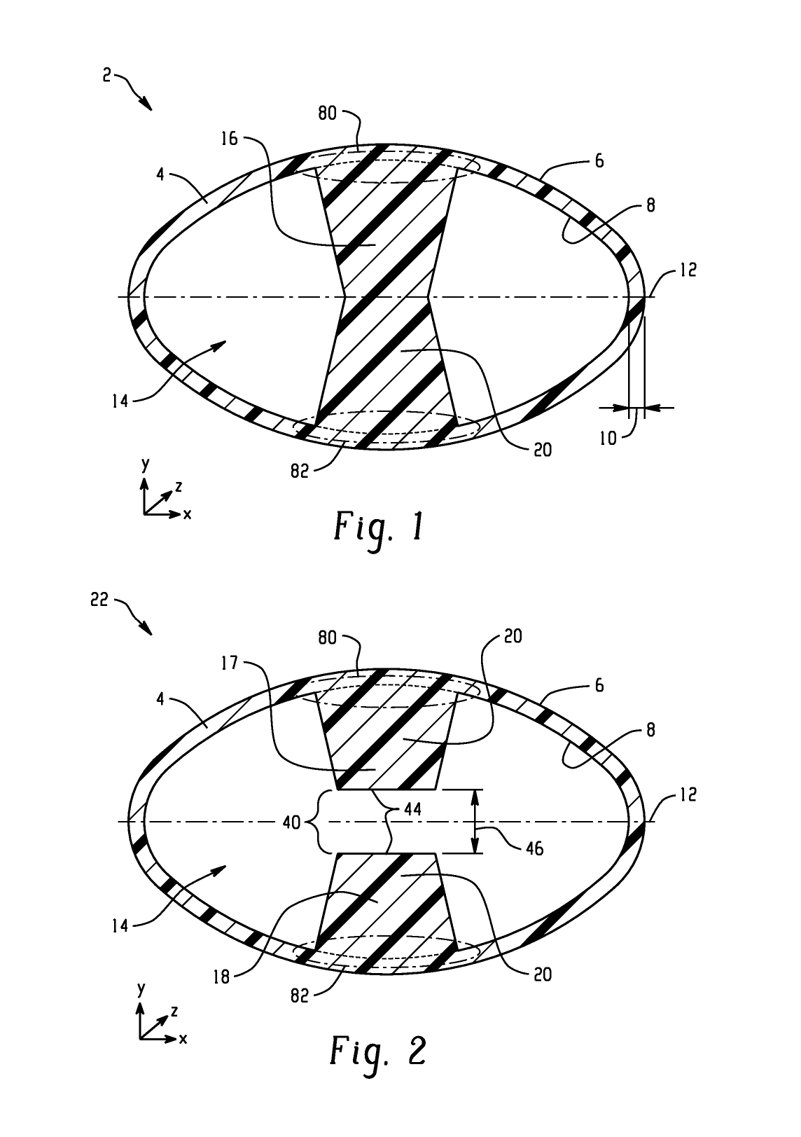

FIG. 1 is an illustration of an article 2. The article 2 can include a closed polymer shell 4 including an outer surface 6, inner surface 8 and centerline 12. The distance between the outer surface 6 and the inner surface 8 can define the wall thickness 10 at any point along the closed polymer shell 4. The wall thickness 10 can be substantially the same throughout the shell (e.g., allowing for slight variation during manufacturing due to tool imperfections, tool wear, local variation in polymer shrinkage or surface tension affects during shrinkage, and the like). The article 2 can include a reinforcement 20. The reinforcement 20 can be in mechanical communication with the closed polymer shell 4. The reinforcement 20 can be a protrusion 16 extending from a first area 80 of the inner surface 8 to a second area 82 of the inner surface 8. A protrusion 16 that extends from a surface of the shell to another surface can be hollow and can form a hole, or aperture, through the closed polymer shell 4. A protrusion 16 can extend in any dimension of the closed polymer shell 4. The first area 80 and second area 82 of the inner surface 8 can be disposed on opposite sides of a centerline 12. The first area 80 can face the second area 82. The inner volume 14 of the closed polymer shell 4 can be defined by the volume enclosed by the inner surface 8 of the closed polymer shell 4 less the volume occupied by the reinforcement 20. The pressure within the inner volume 14 can be any pressure that the closed polymer shell 4 can contain.

FIG. 2 is an illustration of an article 22. The article 22 can include a reinforcement 20. The reinforcement 20 can be in mechanical communication with the closed polymer shell 4. The reinforcement 20 can be formed by at least two protrusions (17, 18) each extending from the inner surface 8 of the closed polymer shell 4. A first protrusion 17 can extend from a first area 80 of the inner surface 8. A second protrusion 18 can extend from a second area 82 of the inner surface 8. The first area 80 and second area 82 can be disposed on opposite sides of a centerline 12. The first area 80 and second area 82 can face one another. The first protrusion 17 and the second protrusion 18 can have surfaces 44 which can have complementary shapes. The surfaces 44 can be spaced apart from one another to define a gap 40 and a gap width 46. The surfaces 44 of the protrusions (17, 18) can oppose deformation of the article 22 along at least one axis (y-axis in FIG. 2). In an embodiment, as a pressure applied to the outer surface 6 increases, the article 22 can begin to deform and protrusions (17, 18) can begin to move toward one another decreasing the gap width 46. As this pressure continues to increase the surfaces 44 can come into contact with one another (gap width 46 can be equal to zero) and can resist further deformation along at least one dimension (e.g., along the y-axis dimension). Once the protrusions (17, 18) abut one another they can resist further deformation of the closed polymer shell 4 at least at the areas (80, 82) from which the protrusions (16, 18) extend. The surfaces 44 can be shaped to engage one another such that when the surfaces 44 abut one another they resist movement in at least one additional dimension (e.g. resist movement along the x-axis dimension or z-axis dimension, such as slipping). The surfaces 44 can be shaped to urge movement of protrusions (17, 18) in a predetermined direction (e.g. x-axis or y-axis dimension) as a pressure applied to the outer surface 6 increases. For example, the surfaces 44 can have complimenting slopes such that a protrusion (17, 18) slips off another protrusion (17, 18) as the pressure applied to the outer surface 6 increases. The pressure within the inner volume 14 can be any pressure that the closed polymer shell 4 can contain.

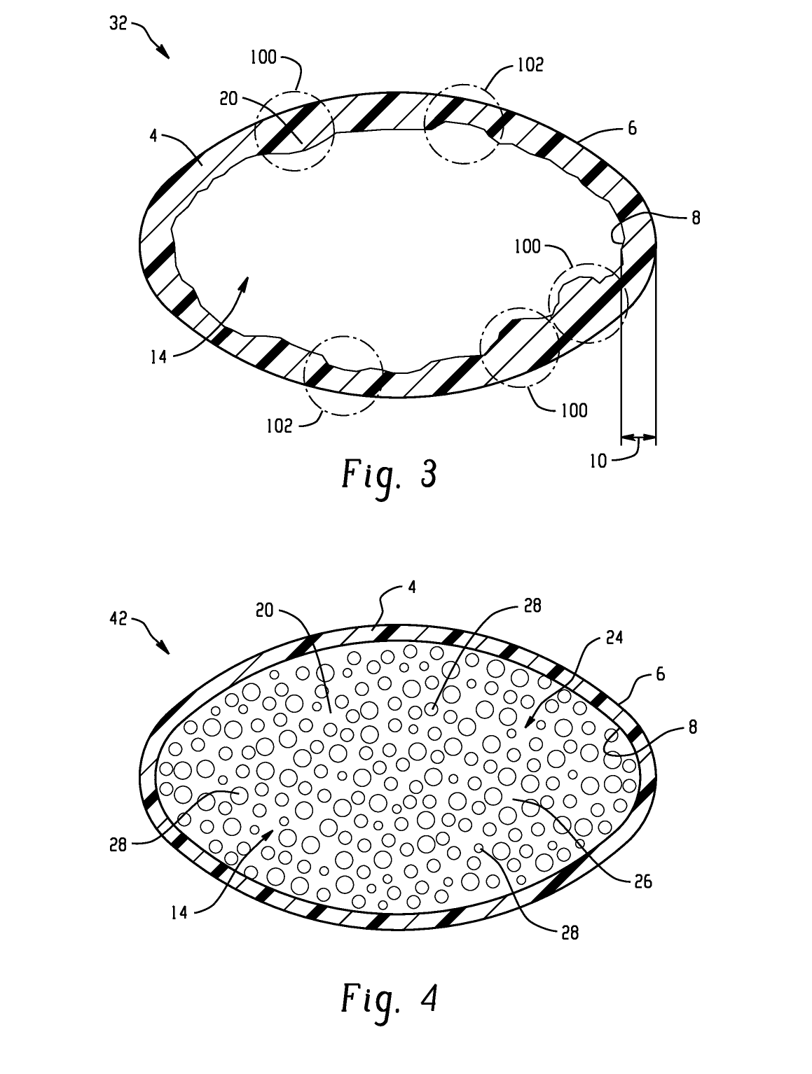

FIG. 3 is an illustration of an article 32. The article can include a closed polymer shell 4. The wall thickness 10 of the closed polymer shell can vary throughout the closed polymer shell 4. The closed polymer shell 4 can include a thicker region 100 and thinner region 102 in comparison to the average thickness of the closed polymer shell 4. The article 32 can include a reinforcement 20. The thicker region 100 of the closed polymer shell 4 can act as the reinforcement 20. The thinner region 102 of the closed polymer shell 4 can act as deformation initiators, which can be the first areas of the shell to deform as a pressure applied to the outer surface 6 of the closed polymer shell 4 increases. The pressure within the inner volume 14 can be any pressure that the closed polymer shell 4 can contain.

FIG. 4 is an illustration of an article 42. The article 42 can include a closed polymer shell 4. The closed polymer shell 4 can include an inner volume 14. The inner volume 14 can include a second polymer material 26. The second polymer material 26 can be a polymer foam material. A polymer foam material can include the same polymer as the polymer of the closed polymer shell 4. A polymer foam material can include solid polymer material and gas inclusions 28. The solid polymer material can form a porous structure 24 adjacent to the gas inclusions 28, such as a closed or open cell foam structure. This porous structure can act as a reinforcement 20. The volume of the gas inclusions 28 can decrease as the pressure applied to the outer surface 6 increases. As the gas inclusion volume decreases the porous structure 24 can help control deformation of the article 42 and store energy like a spring, such that when the pressure applied to the outer surface 6 is reduced. The article can rebound back to its initial volume or shape. The gas of the gas inclusions 28 can include any gas. The pressure within the gas inclusions 28 can be any pressure that the closed polymer shell 4 can contain. The inner volume 14 can be filled with a second polymer material 26. The second polymer material 26 can abut the inner surface 8 of the closed polymer shell 4, such that the second polymer material 26 is in mechanical communication with the closed polymer shell 4. The second polymer material 26 can be free of gas inclusions 28; it can be a non-foamed polymer material. The second polymer material 26 can have a lower durometer hardness value than the durometer hardness value of the polymer of the closed polymer shell 4. The hardness value of a material can be determined using any standard testing method (e.g., ASTM D785, ISO 2039-1).

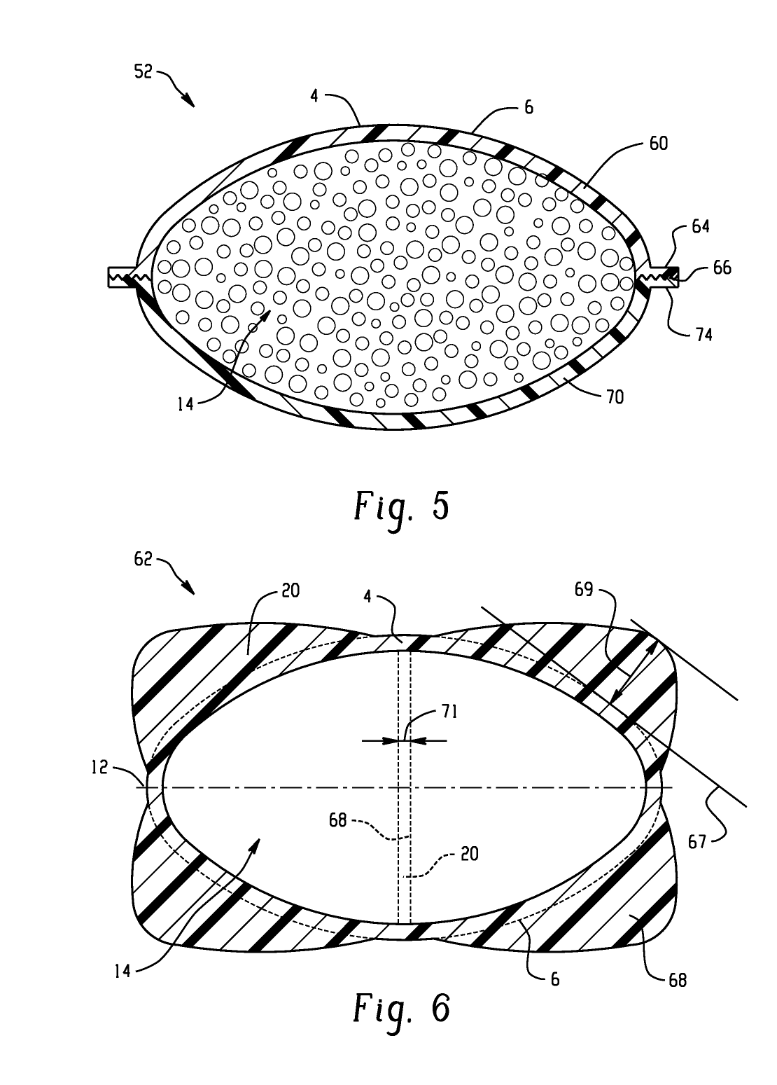

FIG. 5 is an illustration of an article 52. The article 52 can include a closed polymer shell 4. The closed polymer shell can include a first segment 60 and a second segment 70. The first segment 60 can include a first peripheral flange 64. The second segment 70 can include a second peripheral flange 74. The first peripheral flange 64 and second peripheral flange 74 can include alignment features 66 such that the first peripheral flange 64 abuts the second peripheral flange 74 along more than one plane. The alignment features 66 on the peripheral flanges can engage one another. Alignment features 66 can help position two or more segments of a closed polymer shell 4 relative to one another such that they can be aligned and not off-centered from one another. The two segments can be joined along the peripheral flanges (64, 74) using any joining technique known in the art. The pressure within the inner volume 14 can be any pressure that the closed polymer shell 4 can contain.

FIG. 6 is an illustration of an article 62. The article can include a closed polymer shell 4. The article can include a reinforcement 20. The reinforcement 20 can be in mechanical communication with the outer surface 6 of the closed polymer shell 4. The reinforcement 20 can include a rib 68. The rib can extend from the outer surface 6 of the closed polymer shell 4. The rib 60 can extend any distance along a portion of the outer surface 6. The rib can extend around the entire outer surface 6 of the closed polymer shell 4. The rib 68 can extend in any direction. Two or more ribs 68 can extend perpendicular to one another, such as in perpendicular planes. The rib 68 can be discontinuous around a closed polymer shell 4, such as segmented in portions along the closed polymer shell 4. The rib 68 can be segmented into sections and the sections can be coplanar. Sets of coplanar ribs can be disposed perpendicular to one another such as in perpendicular planes. Sets of coplanar ribs can be disposed in intersecting planes that are not perpendicular. The rib 68 can have a varying rib height 69. The rib height can be measured orthogonally from a tangent plane 67 which is tangent to the outer surface 6 of the closed polymer shell 4. The rib 68 can extend in a helix around a centerline 12 of the article 2, such as like threads of a screw. The thickness 71 of a rib 68 can vary as a function of the rib height 69. The rib 68 can be thicker at its base, where it attaches to the closed polymer shell 4. The rib 68 can have a constant thickness as a function of rib height 69. The pressure within the inner volume 14 can be any pressure that the closed polymer shell 4 can contain.

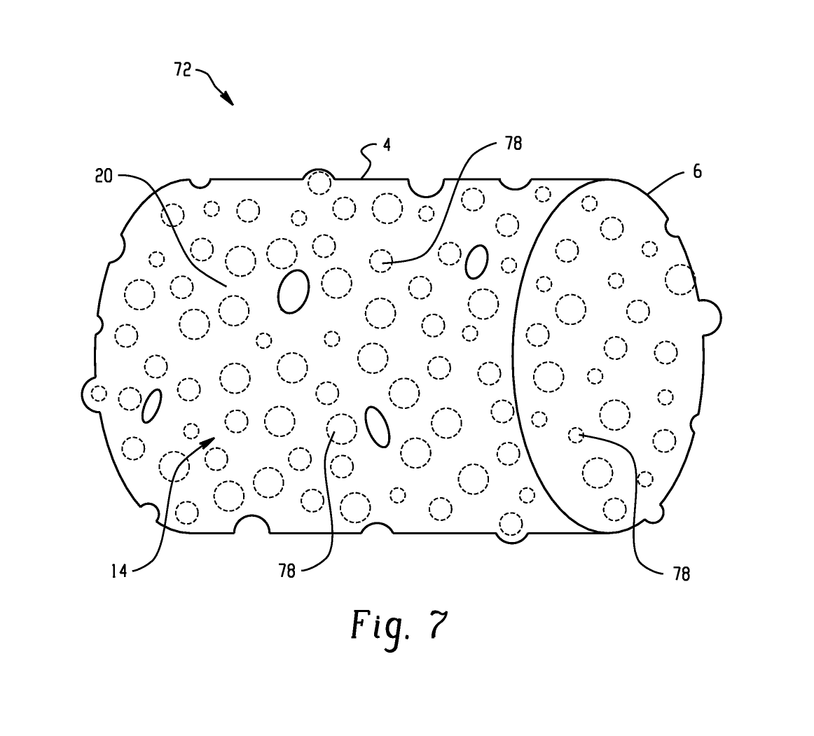

FIG. 7 is an illustration of an article 72. The article can include a closed polymer shell 4 which surrounds gas inclusions 78. The article 72 can have any shape. The article 72 can be formed by an extrusion process. The gas inclusions 78 can be formed during an extrusion process. The gas inclusions 78 can include any gas. The inner volume of the article 72 can include gas inclusions 78. The pressure of the gas within the gas inclusions 78 can be any pressure that the closed polymer shell 4 can contain. The outer surface 6 of the closed polymer shell 4 can be irregular. Crater like, or bubble like, formations can be disposed at the outer surface 6. These formations can be due to gas inclusions 78 moving to the outer surface 6 during manufacturing of the article 72, e.g., while the closed polymer shell 4 is molten.

The inner surface of a closed polymer shell can define the inner volume of the article. The initial inner volume of the article can be 1 cubic millimeter (mm³) to 10 cubic decimeters (dm³), for example 10 mm³ to 1 dm³, or, 10 mm³ to 25 cubic centimeters (cm³). The inner volume of the article can include any material. The inner volume of the article can include a fluid, e.g., air, inert gas. The inner volume of the article can be pressurized.

The article can be capable of elastic deformation. In this way, the article can deform as a pressure applied to the outside surface of the article increases and return to its original shape as the pressure is reduced.

The article can be configured to start elastically deforming at an initial pressure and continue to deform until it reaches a final pressure. The initial pressure can be and final pressure

The inner volume of an article can include a material that has a specific gravity that is greater than the specific gravity of a fluid surrounding the article. In this case, the article can float, or rise, within the fluid. The inner volume of an article can include a material that has a specific gravity that is less than the specific gravity of a fluid surrounding the article. In this case, the article can sink, or fall, within the fluid.

The article can be formed by injection molding, e.g., gas assist injection molding, two shot injection molding, and the like. The article can be formed by insert molding or co-molding. For example a second polymer can be placed into a mold and a closed polymer shell can be molded over the second polymer. The closed polymer shell of the article can be thermoformed, vacuum formed or forming in a similar fashion.

Besides being made by injection molding and other molding or forming processes, these elastically deformable articles of manufacture may be made by any suitable additive manufacturing processes including stereolithography, fused deposition modeling, selective laser sintering and 3D printing processes.

A closed polymer shell can be formed in segments and the segments joined together. Segments of a closed polymer shell can include a peripheral flange extending from the periphery, or edge, of a segment of a closed polymer shell. Two or more segments can be joined along a peripheral flange to form a closed polymer shell. A flange can include alignment features which can aid in aligning segments, such that the segments are not off-centered or misaligned from one another when the segments are brought together or joined. Alignment features of a first peripheral flange can be shaped complementary to alignment features of another peripheral flange. Alignment features can include complementary protrusion and recess, threads, and the like, where the peripheral flange surfaces of two or more segments can abut one another along more than one plane. Joining segments together can include any mechanical, thermal, or chemical joining technique. For example joining can include hot plate welding, laser welding, rotary welding, thermal welding, ultrasonic welding, vibration welding, solvent bonding, melt bonding, adhesive bonding, or a combination comprising at least one of the foregoing.

The articles as disclosed herein can be used in a piping system to mitigate annular pressure buildup or other pressure excursions, such as cyclic pressure excursions, within the system. The articles can be mixed with a fluid used in the piping system, for example a reactant, as solvent, a wastewater or other fluid to be recycled, or a well bore fluid or other fluid commonly used in manufacturing, purification, or drilling operations. The fluid can be introduced to a piping system. The fluid can be pumped into a pipe, an annular space or any volume where a pressure excursion can be expected. The piping system can include a pipe and a surrounding barrier forming an annulus between the pipe and the barrier. The piping system can include a first pipe and a surrounding second pipe forming an annulus between the first pipe and the second pipe. The piping system can include a plug or other barrier capable of preventing mass flow axially through the annulus or pipe. The pipe or annulus can form a closed system. The system can be a pseudo-closed system such that the system can permit some transfer of mass or energy to adjacent barriers, annuli, fluids, pipes, or other adjacent equipment, but such transfer can be insufficient in reducing a pressure excursion or pressure buildup that is capable of causing cracks or rupture of barriers, pipes, plugs or other equipment to relieve the pressure excursion or pressure buildup. The pressure in the piping annulus can increase due to thermal energy transfer from adjacent pipes, e.g., coaxial pipes. The piping systems can include retainers that are capable of retaining the articles of manufacture within a predetermined volume pipe or annulus.

The article can include a polymer. The polymer can be a thermoplastic polymer. The thermoplastic polymer can be generally considered a high temperature, hydrolytically and chemically stable polymer. The thermoplastic polymer can have a thermal decomposition temperature of 180° C. or higher, for example, 200° C. or higher, or, 220° C. or higher, or, 250° C. or higher. There is no particular upper limit to the thermal decomposition temperature, although 400° C. can be mentioned. The polymer can be hydrolytically stable at high temperatures, for example, 180° C. or higher, or, 200° C. or higher, or, 220° C. or higher, or, 250° C. or higher. There is no particular upper limit temperature for the hydrolytic stability of the polymer, although 400° C. can be mentioned.

A thermoplastic polymer that can meet these conditions can contain aromatic groups, for example, polyamide (PA), polyphthalamides (PPA), aromatic polyimides, aromatic polyetherimides (PEI), polyphenylene sulfides (PPS), polyaryletherketones (PAEK), polyetherether ketones (PEEK), polyetherketoneketones (PEKK), polyethersulfones (PES), polyphenylenesulfones (PPSU), polyphenylenesulfone ureas, self-reinforced polyphenylene (SRP), or a combination comprising at least one of the foregoing. The thermoplastic polymer can be a dendrimer. The thermoplastic polymer can be linear, or branched and can include a homopolymer or copolymer comprising units of two or more of the foregoing thermoplastic polymers, for example polyamide-imides (PAI). The copolymers can be random, alternating, graft, and block copolymers having two or more blocks of different homopolymers, random, or alternating copolymers. Specific high temperature polymers can be the aromatic polyetherimides available from SABIC under the trade name ULTEM. The high temperature thermoplastic polymers can be obtained and used in either pellet or powder form.

Aromatic polyetherimides can include more than 1, for example 10 to 1000, or 10 to 500, structural units of formula (1)

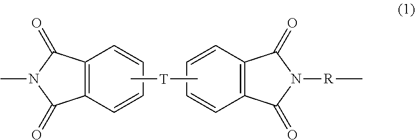

wherein each R can be the same or different, and can be a substituted or unsubstituted divalent organic group, such as a C₆₋₂₀ aromatic hydrocarbon group or a halogenated derivative thereof, a straight or branched chain C₂₋₂₀ alkylene group or a halogenated derivative thereof, a C₃₋₈ cycloalkylene group or halogenated derivative thereof, in particular a divalent group of formula (2)

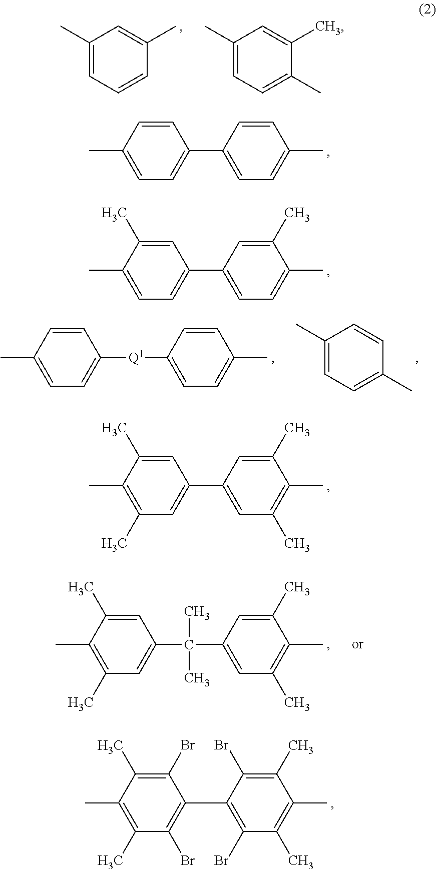

wherein Q¹ is —O—, —S—, —C(O)—, —SO₂—, —SO—, or —C_{y}H_{2y}— wherein y is an integer from 1 to 5 or a halogenated derivative thereof (which includes perfluoroalkylene groups). In an embodiment R is a m-phenylene or p-phenylene.

Further in formula (1), T is —O— or a group of the formula —O—Z—O— wherein the divalent bonds of the —O— or the —O—Z—O— group are in the 3,3′, 3,4′, 4,3′, or the 4,4′ positions. The group Z in —O—Z—O— of formula (1) is also a substituted or unsubstituted divalent organic group, and can be an aromatic C₆₋₂₄ monocyclic or polycyclic moiety optionally substituted with 1 to 6 C₁₋₈ alkyl groups, 1 to 8 halogen atoms, or a combination thereof, provided that the valence of Z is not exceeded. Exemplary groups Z include groups derived from a dihydroxy compound of formula (3)

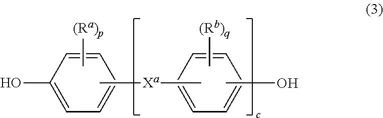

wherein R^{a} and R^{b} can be the same or different and are a halogen atom or a monovalent C₁₋₆ alkyl group, for example; p and q are each independently integers of 0 to 4; c is 0 to 4; and X^{a} is a bridging group connecting the hydroxy-substituted aromatic groups, where the bridging group and the hydroxy substituent of each C₆ arylene group are disposed ortho, meta, or para (specifically para) to each other on the C₆ arylene group. The bridging group X^{a} can be a single bond, —O—, —S—, —S(O)—, —S(O)₂—, —C(O)—, or a C₁₋₁₈ organic bridging group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. A specific example of a group Z is a divalent group of formulas (3a)

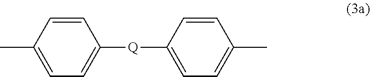

wherein Q is —O—, —S—, —C(O)—, —SO₂—, —SO—, or —C_{y}H_{2y}— wherein y is an integer from 1 to 5 or a halogenated derivative thereof (including a perfluoroalkylene group). In a specific embodiment Z is a derived from bisphenol A, such that Q in formula (3a) is 2,2-isopropylidene.

In an embodiment in formula (1), R is m-phenylene or p-phenylene and T is —O—Z—O wherein Z is a divalent group of formula (3a). Alternatively, R is m-phenylene or p-phenylene and T is —O—Z—O wherein Z is a divalent group of formula (3a) and Q is 2,2-isopropylidene.

In some embodiments, the polyetherimide can be a copolymer, for example, a polyetherimide sulfone copolymer comprising structural units of formula (1) wherein at least 50 mole % of the R groups are of formula (2) wherein Q¹ is —SO₂— and the remaining R groups are independently p-phenylene or m-phenylene or a combination comprising at least one of the foregoing; and Z is 2,2-(4-phenylene)isopropylidene. Alternatively, the polyetherimide optionally comprises additional structural imide units, for example imide units of formula (4):

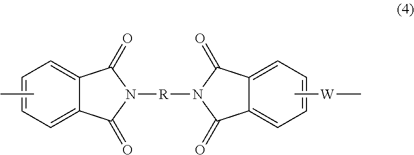

wherein R is as described in formula (1) and W is a linker of the formulas:

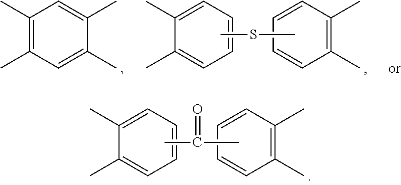

These additional structural imide units can be present in amounts from 0 to 10 mole % of the total number of units, specifically 0 to 5 mole %, more specifically 0 to 2 mole %. In an embodiment no additional imide units are present in the polyetherimide.

The polyetherimide can be prepared by any of the methods well known to those skilled in the art, including the reaction of an aromatic bis(ether anhydride) of formula (5):

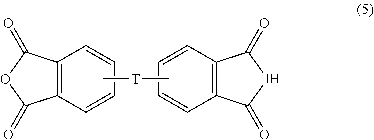

with an organic diamine of formula (6):

H₂N—R—NH₂ (6)

wherein T and R are defined as described above. Copolymers of the polyetherimides can be manufactured using a combination of an aromatic bis(ether anhydride) of formula (5) and a different bis(anhydride), for example a bis(anhydride) wherein T does not contain an ether functionality, for example T is a sulfone.

Illustrative examples of bis(anhydride)s include 3,3-bis[4-(3,4-dicarboxyphenoxy)phenyl]propane dianhydride; 4,4′-bis(3,4-dicarboxyphenoxy)diphenyl ether dianhydride; 4,4′-bis(3,4-dicarboxyphenoxy)diphenyl sulfide dianhydride; 4,4′-bis(3,4-dicarboxyphenoxy)benzophenone dianhydride; 4,4′-bis(3,4-dicarboxyphenoxy)diphenyl sulfone dianhydride; 2,2-bis[4-(2,3-dicarboxyphenoxy)phenyl]propane dianhydride; 4,4′-bis(2,3-dicarboxyphenoxy)diphenyl ether dianhydride; 4,4′-bis(2,3-dicarboxyphenoxy)diphenyl sulfide dianhydride; 4,4′-bis(2,3-dicarboxyphenoxy)benzophenone dianhydride; 4,4′-bis(2,3-dicarboxyphenoxy)diphenyl sulfone dianhydride; 4-(2,3-dicarboxyphenoxy)-4′-(3,4-dicarboxyphenoxy)diphenyl-2,2-propane dianhydride; 4-(2,3-dicarboxyphenoxy)-4′-(3,4-dicarboxyphenoxy)diphenyl ether dianhydride; 4-(2,3-dicarboxyphenoxy)-4′-(3,4-dicarboxyphenoxy)diphenyl sulfide dianhydride; 4-(2,3-dicarboxyphenoxy)-4′-(3,4-dicarboxyphenoxy)benzophenone dianhydride; and, 4-(2,3-dicarboxyphenoxy)-4′-(3,4-dicarboxyphenoxy)diphenyl sulfone dianhydride, as well as various combinations comprising at least one of the foregoing.

Examples of organic diamines include ethylenediamine, propylenediamine, trimethylenediamine, diethylenetriamine, triethylene tetramine, hexamethylenediamine, heptamethylenediamine, octamethylenediamine, nonamethylenediamine, decamethylenediamine, 1,12-dodecanediamine, 1,18-octadecanediamine, 3-methylheptamethylenediamine, 4,4-dimethylheptamethylenediamine, 4-methylnonamethylenediamine, 5-methylnonamethylenediamine, 2,5-dimethylhexamethylenediamine, 2,5-dimethylheptamethylenediamine, 2,2-dimethylpropylenediamine, N-methyl-bis (3-aminopropyl) amine, 3-methoxyhexamethylenediamine, 1,2-bis(3-aminopropoxy) ethane, bis(3-aminopropyl) sulfide, 1,4-cyclohexanediamine, bis-(4-aminocyclohexyl) methane, m-phenylenediamine, p-phenylenediamine, 2,4-diaminotoluene, 2,6-diaminotoluene, m-xylylenediamine, p-xylylenediamine, 2-methyl-4,6-diethyl-1,3-phenylene-diamine, 5-methyl-4,6-diethyl-1,3-phenylene-diamine, benzidine, 3,3′-dimethylbenzidine, 3,3′-dimethoxybenzidine, 1,5-diaminonaphthalene, bis(4-aminophenyl) methane, bis(2-chloro-4-amino-3,5-diethylphenyl) methane, bis(4-aminophenyl) propane, 2,4-bis(p-amino-t-butyl) toluene, bis(p-amino-t-butylphenyl) ether, bis(p-methyl-o-aminophenyl) benzene, bis(p-methyl-o-aminopentyl) benzene, 1,3-diamino-4-isopropylbenzene, bis(4-aminophenyl) sulfide, bis-(4-aminophenyl) sulfone, and bis(4-aminophenyl) ether. Combinations of these compounds can also be used. In some embodiments the organic diamine is m-phenylenediamine, p-phenylenediamine, sulfonyl dianiline, or a combination comprising one or more of the foregoing.

The polyetherimides can have a melt index of 0.1 to 10 grams per minute (g/min), as measured by American Society for Testing Materials (ASTM) D1238 at 340 to 370° C., using a 6.7 kilogram (kg) weight. In some embodiments, the polyetherimide polymer has a weight average molecular weight (Mw) of 1,000 to 150,000 grams/mole (Dalton), as measured by gel permeation chromatography, using polystyrene standards. In some embodiments the polyetherimide has an Mw of 10,000 to 80,000 Daltons. Such polyetherimide polymers typically have an intrinsic viscosity greater than 0.2 deciliters per gram (dl/g), or, more specifically, 0.35 to 0.7 dl/g as measured in m-cresol at 25° C.

The term “alkyl” can include branched or straight chain, unsaturated aliphatic C₁₋₃₀ hydrocarbon groups e.g., methyl, ethyl, n-propyl, i-propyl, n-butyl, s-butyl, t-butyl, n-pentyl, s-pentyl, n- and s-hexyl, n-and s-heptyl, and, n- and s-octyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups.

“Alkylene” means a straight or branched chain, saturated, divalent aliphatic hydrocarbon group (e.g., methylene (—CH₂—) or, propylene (—(CH₂)₃—)).

“Cycloalkylene” means a divalent cyclic alkylene group, —CₙH₂ₙ₋ₓ, wherein x represents the number of hydrogens replaced by cyclization(s). “Cycloalkenyl” means a monovalent group having one or more rings and one or more carbon-carbon double bond in the ring, wherein all ring members are carbon (e.g., cyclopentyl and cyclohexyl).

The term “aryl” means an aromatic hydrocarbon group containing the specified number of carbon atoms, such as to phenyl, tropone, indanyl, or naphthyl.

The prefix “halo” means a group or compound including one more of a fluoro, chloro, bromo, iodo, and astatino substituent. A combination of different halo groups (e.g., bromo and fluoro) can be present. In an embodiment only chloro groups are present.

The prefix “hetero” means that the compound or group includes at least one ring member that is a heteroatom (e.g., 1, 2, or 3 heteroatom(s)), wherein the heteroatom(s) is each independently N, O, S, or P.

“Substituted” means that the compound or group is substituted with at least one (e.g., 1, 2, 3, or 4) substituents independently selected from, a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl)a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded.

A polymer disposed in the inner volume of an article can include any of the foregoing polymer materials. Additionally, a polymer disposed in the inner volume can include polyester (PE), polyetherimide-siloxane copolymer, or a combination comprising at least one of the foregoing.

Any of the foregoing polymer materials can be used in a reinforced composite polymer material with the incorporation of reinforcing material. As used herein, a reinforced composite polymer can include a polymer and reinforcing material, such as fibers, (continuous, chopped, woven, and the like) formed of aramid, carbon, basalt, glass, plastic, metal (e.g. steel, aluminum, magnesium), quartz, boron, cellulose, liquid crystal polymer, high tenacity polymer (e.g., polypropylene, polyethylene, poly(hexano-6-lactam), poly[imino(1,6-dioxohexamethylene) imnohexamethylene]), thermoplastic polymer, thermoset polymer, or natural fibers, or a combination comprising at least one of the foregoing. In an embodiment, the first polymer material can include a reinforcing fiber chosen from carbon fiber, glass fiber, basalt fiber, aramid fiber, or a combination comprising at least one of the foregoing.

Ebodiment 1: An elastically deformable article of manufacture comprising: a closed polymer shell having an outer surface, an inner surface, and an inner volume; a reinforcement in mechanical communication with an area of either the outer surface, the inner surface, or both the outer surface and the inner surface; wherein the closed polymer shell comprises a first polymer material having a thermal decomposition temperature of greater than or equal to 180° C.; wherein the article is configured such that the inner volume reduces from an initial inner volume as a pressure applied to the outer surface is increased to a threshold pressure and rebounds to greater than 75%, preferably greater than 90%, of the initial inner volume as the pressure decreases from the threshold pressure over at least two pressure cycles.

Ebodiment 2: The elastically deformable article of manufacture of Ebodiment 1, wherein the article is configured such that the inner volume reduces from an initial inner volume as a pressure applied to the outer surface is increased to a threshold pressure and rebounds to greater than 75% of the initial inner volume as the pressure decreases from the threshold pressure over five to eight pressure cycles.

Ebodiment 3: The elastically deformable article of manufacture of Ebodiment 1, wherein the article is configured such that the inner volume reduces from an initial inner volume as a pressure applied to the outer surface is increased to a threshold pressure and rebounds to greater than 90% of the initial inner volume as the pressure decreases from the threshold pressure over at least ten pressure cycles.

Ebodiment 4: The elastically deformable article of manufacture of any of Embodiments 1-3, wherein the first polymer material has a thermal decomposition temperature of 180° C. to 300° C.

Ebodiment 5: The elastically deformable article of manufacture of any of Embodiments 1-4, wherein the first polymer material further comprises a modulus of elasticity of greater than or equal to 3 GPa, determined in accordance with ASTM D638-10. Alternatively, the elastically deformable article of manufacture of any of Embodiments 1-4 can have one or more of a thermal decomposition temperature of 180° C. to 300° C. and a modulus of elasticity of greater than or equal to 3 GPa, determined in accordance with ASTM D638-10.

Ebodiment 6: The elastically deformable article of manufacture of any of Embodiments 1-5, wherein the first polymer material comprises a polyamide, polyphthalamide (PPA), aromatic polyimide (TPI), aromatic polyetherimide, polyphenylene sulfide (PPS), polyaryletherketone (PAEK), polyetherether ketone (PEEK), polyetherketoneketone (PEKK), polyethersulfone (PES), polyphenylenesulfone (PPSU), polyphenylenesulfone urea, self-reinforced polyphenylene (SRP), an ionomer thereof, a copolymer thereof, or a combination comprising at least one of the foregoing, preferably wherein the first polymer material comprises an aromatic polyetherimide.

Ebodiment 7: The elastically deformable article of manufacture of any of Embodiments 1-6, wherein the first polymer material further comprises a reinforcing fiber chosen from carbon fiber, glass fiber, basalt fiber, aramid fiber, or a combination comprising at least one of the foregoing.

Ebodiment 8: The elastically deformable article of manufacture of any of Embodiments 1-7, wherein the first polymer material is an aromatic polyetherimide.

Ebodiment 9: The elastically deformable article of manufacture of any of Embodiments 1-8, wherein the reinforcement is in mechanical communication with an area of the inner surface of the closed polymer shell.

Ebodiment 10: The elastically deformable article of manufacture of any of Embodiments 1-9, wherein the reinforcement comprises a protrusion from the inner surface, more preferably wherein the protrusion extends from a first area of the inner surface to a second area of the inner surface.

Ebodiment 11: The elastically deformable article of manufacture of Ebodiment 10, wherein the protrusion extends from a first area of the inner surface to a second area of the inner surface.

Ebodiment 12: The elastically deformable article of manufacture of Ebodiment 11, wherein the first area and the second area of the inner surface face one another and are disposed on opposite sides of a centerline.

Ebodiment 13: The elastically deformable article of manufacture of Ebodiment 10, wherein the reinforcement comprises at least two protrusions from the inner surface; wherein the protrusions oppose one another, wherein a gap having a gap width is disposed between the protrusions when the article has its initial volume, wherein as the initial volume of the article of manufacture is decreased the gap width decreases, and wherein at the threshold pressure the gap width is zero such that the protrusions abut one another.

Ebodiment 14: The elastically deformable article of manufacture of any of Embodiments 1-9, wherein the reinforcement comprises a polymer foam material disposed within the inner volume, preferably wherein the polymer foam material is the same material as the first polymer material of the shell.

Ebodiment 15: The elastically deformable article of manufacture of Ebodiment 14, wherein the polymer foam material is the same material as the first polymer material of the shell.

Ebodiment 16: The elastically deformable article of manufacture of any of Embodiments 1-9, wherein a wall thickness defined by the distance between the inner surface and outer surface of the closed polymer shell varies along the perimeter of the shell such that the wall thickness has thicker portions, and wherein the thicker portions act as the reinforcement.

Ebodiment 17: The elastically deformable article of manufacture of Ebodiment 16, wherein the article is manufactured by gas-assist injection molding.

Ebodiment 18: The elastically deformable article of manufacture of any of Embodiments 1-9, wherein the inner volume comprises a second polymer material having a lower durometer value than the first polymer material of the shell.

Ebodiment 19: The elastically deformable article of manufacture of Ebodiment 18, wherein the second polymer material comprises polyamide (PA), polyphthalamide (PPA), polyester (PE), polyetherimide, polyetherimide-siloxane copolymer, or a combination comprising at least one of the foregoing.

Ebodiment 20: The elastically deformable article of manufacture of any of Embodiments 18-19 wherein the first polymer material is molded over the second polymer material in a co-molding process or the second polymer material is molded within the first polymer material in an insert molding process.

Ebodiment 21: The elastically deformable article of manufacture of any of Embodiments 18-19, wherein the closed polymer shell comprises two or more thermoformed segments joined together.

Ebodiment 22: The elastically deformable article of manufacture of any of Embodiments 1-9, wherein the shell comprises two or more injection molded segments, wherein each segment comprises a peripheral flange extending from its outer surface and the peripheral flanges of two or more segments are joined together.

Ebodiment 23: The elastically deformable article of manufacture of any of Embodiments 21-22, wherein the segments are joined together by hot plate welding, laser welding, rotary welding, thermal welding, ultrasonic welding, vibration welding, solvent bonding, or melt bonding.

Ebodiment 24: The elastically deformable article of manufacture of any of Embodiments 1-23, wherein the reinforcement is in mechanical communication with an area of the outer surface of the closed polymer shell.

Ebodiment 25: The elastically deformable article of manufacture of any of Embodiments 1-24, wherein the reinforcement comprises a rib extending from an area of the outer surface of the closed polymer shell.

Ebodiment 26: The elastically deformable article of manufacture of Ebodiment 25, wherein the reinforcement comprises two or more ribs.

Ebodiment 27: The elastically deformable article of manufacture of any of Embodiments 24-26, wherein the reinforcement comprises eight ribs, wherein a first set of four ribs are coplanar and are disposed in a first plane around 75% or more of the perimeter of the outer surface of the article in the first plane, wherein a second set of four ribs are coplanar and are disposed in a second plane around 75% or more of the perimeter of the outer surface of the article in the second plane, and wherein the first and second planes are orthogonal to one another.

Ebodiment 28: The elastically deformable article of manufacture of any of Embodiments 24-27, wherein a rib has a varying height measured orthogonal to the outer surface of the closed polymer shell.

Ebodiment 29: The elastically deformable article of manufacture of any of Embodiments 1-28, wherein a portion of the closed polymer shell wall has a thickness of 0.1 millimeter (mm) to 25 millimeters (mm).

Ebodiment 30: The elastically deformable article of manufacture of any of Embodiments 1-29, wherein the closed polymer shell has a height of 1 millimeter (mm) to 150 millimeters (mm).

Ebodiment 31: The elastically deformable article of manufacture of any of Embodiments 1-30, wherein the closed polymer shell has a length of 1 millimeter (mm) to 150 millimeters (mm).

Ebodiment 32: The elastically deformable article of manufacture of any of Embodiments 1-31, wherein the closed polymer shell has total volume of 1 cubic millimeter (mm³) to 10 cubic decimeters (dm³). Alternatively, the closed polymer shell has a height of 1 millimeter (mm) to 150 millimeters (mm), a length of 1 millimeter (mm) to 150 millimeters (mm) and a total volume of 1 cubic millimeter (mm³) to 10 cubic decimeters (dm³).

Ebodiment 33: The elastically deformable article of manufacture of any of Embodiments 1-32, wherein the outer surface has a smooth and non-porous area.

Ebodiment 34: The elastically deformable article of manufacture of any of Embodiments 1-33, wherein the article comprises two or more segments joined together.

Ebodiment 35: The elastically deformable article of manufacture of any of Embodiments 1-9, wherein the article comprises an extruded thermoplastic pellet, wherein the inner volume comprises the first polymer material and gas inclusions and wherein the first polymer material of the inner volume acts as the reinforcement.

Ebodiment 36: The elastically deformable article of manufacture of any of Embodiments 1-35, wherein the inner volume is sealed such as to prevent ingress of material from outside the outer surface of the shell into the inner volume.

Ebodiment 37: A method of absorbing pressure excursions in a piping system comprising: introducing a fluid composition comprising a plurality of elastically deformable articles of any of Embodiments 1-36 to an annulus of a piping system having a annulus pressure; allowing the plurality of elastically deformable articles to deform due to pressure excursions within the annulus.

Ebodiment 38: The method of Ebodiment 37, wherein the plurality of elastically deformable articles have varying sizes.

Ebodiment 39: The method of any of Embodiments 37-38, wherein the size of the plurality of elastically deformable articles varies along a length of the piping system.

Ebodiment 40: The method of any of Embodiments 37-39, wherein the inner volume of the plurality of elastically deformable articles varies along a length of the piping system.

Ebodiment 41: A piping system comprising: a pipe; a barrier surrounding the pipe forming a annulus between the pipe and the barrier, wherein the barrier is sealed to form a closed annulus; a plurality of elastically deformable articles of any of Embodiments 1-36.

Ebodiment 42: The piping system of Ebodiment 41, further comprising a retainer for retaining the plurality of elastically deformable articles within a length of the annulus.

Ebodiment 43: The piping system of any of Embodiments 41-42, wherein the size of the plurality of elastically deformable articles varies along a length of the piping system.

Ebodiment 44: The piping system of any of Embodiments 41-43, wherein the inner volume of the plurality of elastically deformable articles varies along a length of the piping system.

In general, the invention may alternatively comprise, consist of, or consist essentially of, any appropriate components herein disclosed. The invention may additionally, or alternatively, be formulated so as to be devoid, or substantially free, of any components, materials, ingredients, adjuvants or species used in the prior art compositions or that are otherwise not necessary to the achievement of the function or objectives of the present invention.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. “Or” means “and/or”. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, or characteristic) described in connection with the embodiment is included in at least one embodiment described herein, and may or may not be present in other embodiments. In addition, it is to be understood that the described elements may be combined in any suitable manner in the various embodiments.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

I/We claim:

1. An elastically deformable article of manufacture comprising:
a closed polymer shell having an outer surface, an inner surface, and an inner volume;
a reinforcement in mechanical communication with an area of either the outer surface, the inner surface, or both the outer surface and the inner surface;
wherein the closed polymer shell comprises a first polymer material having a thermal decomposition temperature of greater than or equal to 180° C.;
wherein the article is configured such that the inner volume reduces from an initial inner volume as a pressure applied to the outer surface is increased to a threshold pressure and rebounds to greater than 75% of the initial inner volume as the pressure decreases from the threshold pressure over at least two pressure cycles.

2. The elastically deformable article of manufacture of claim 1, wherein the article is configured such that the inner volume reduces from an initial inner volume as a pressure applied to the outer surface is increased to a threshold pressure and rebounds to greater than 90% of the initial inner volume as the pressure decreases from the threshold pressure over five to eight pressure cycles.

3. The elastically deformable article of manufacture of claim 1, wherein the first polymer material has one or more of a thermal decomposition temperature of 180° C. to 300° C. and a modulus of elasticity of greater than or equal to 3 GPa, determined in accordance with ASTM D638-10.

4. The elastically deformable article of manufacture of claim 1, wherein the first polymer material comprises a polyamide, polyphthalamide (PPA), aromatic polyimide (TPI), aromatic polyetherimide, polyphenylene sulfide (PPS), polyaryletherketone (PAEK), polyetherether ketone (PEEK), polyetherketoneketone (PEKK), polyethersulfone (PES), polyphenylenesulfone (PPSU), polyphenylenesulfone urea, self-reinforced polyphenylene (SRP), an ionomer thereof, a copolymer thereof, or a combination comprising at least one of the foregoing, preferably wherein the first polymer material comprises an aromatic polyetherimide.

5. The elastically deformable article of manufacture of claim 1, wherein the first polymer material further comprises a reinforcing fiber chosen from carbon fiber, glass fiber, basalt fiber, aramid fiber, or a combination comprising at least one of the foregoing.

6. The elastically deformable article of manufacture of claim 1, wherein the reinforcement is in mechanical communication with an area of the inner surface of the closed polymer shell, wherein the reinforcement comprises a protrusion from the inner surface, and wherein the protrusion extends from a first area of the inner surface to a second area of the inner surface.

7. The elastically deformable article of manufacture of claim 6, wherein the reinforcement comprises a polymer foam material disposed within the inner volume, and wherein the polymer foam material is the same material as the first polymer material of the shell.

8. The elastically deformable article of manufacture of claim 1, wherein a wall thickness defined by the distance between the inner surface and outer surface of the closed polymer shell varies along the perimeter of the shell such that the wall thickness has thicker portions, and wherein the thicker portions act as the reinforcement.

9. The elastically deformable article of manufacture of claim 1, wherein the inner volume comprises a second polymer material having a lower durometer value than the first polymer material of the shell, wherein the second polymer material comprises polyamide (PA), polyphthalamide (PPA), polyester (PE), polyetherimide, polyetherimide-siloxane copolymer, or a combination comprising at least one of the foregoing.

10. The elastically deformable article of manufacture of claim 1, wherein the shell comprises two or more injection molded segments, wherein each segment comprises a peripheral flange extending from its outer surface and the peripheral flanges of two or more segments are joined together.

11. The elastically deformable article of manufacture of claim 1, wherein the reinforcement is in mechanical communication with an area of the outer surface of the closed polymer shell.

12. The elastically deformable article of manufacture of claim 11, wherein the reinforcement comprises a rib extending from an area of the outer surface of the closed polymer shell.

13. The elastically deformable article of manufacture of claim 12, wherein the reinforcement comprises eight ribs, wherein a first set of four ribs are coplanar and are disposed in a first plane around 75% or more of the perimeter of the outer surface of the article in the first plane, wherein a second set of four ribs are coplanar and are disposed in a second plane around 75% or more of the perimeter of the outer surface of the article in the second plane, and wherein the first and second planes are orthogonal to one another.

14. The elastically deformable article of manufacture of claim 12, wherein a rib has a varying height measured orthogonal to the outer surface of the closed polymer shell.

15. The elastically deformable article of manufacture of claim 1, wherein the closed polymer shell has a height of 1 millimeter (mm) to 150 millimeters (mm), a length of 1 millimeter (mm) to 150 millimeters (mm) and a total volume of 1 cubic millimeter (mm3) to 10 cubic decimeters (dm3).

16. The elastically deformable article of manufacture of claim 1, wherein the article comprises two or more segments joined together.

17. The elastically deformable article of manufacture of claim 1, wherein the inner volume is sealed such as to prevent ingress of material from outside the outer surface of the shell into the inner volume.

18. A method of absorbing pressure excursions in a piping system comprising:
introducing a fluid composition comprising a plurality of elastically deformable articles of claim 1 to an annulus of a piping system having a annulus pressure;
allowing the plurality of elastically deformable articles to deform due to pressure excursions within the annulus.

19. A piping system comprising:
a pipe;
a barrier surrounding the pipe forming a annulus between the pipe and the barrier, wherein the barrier is sealed to form a closed annulus;
a plurality of elastically deformable articles of claim 1.

20. The piping system of claim 19, further comprising a retainer for retaining the plurality of elastically deformable articles within a length of the annulus.
